(19) United States
(12) Patent Application Publication
(10) Pub. No.: US 2005/0155754 A1
(43) Pub. Date: Jul. 21, 2005

(54) Reformate cooling system for use in a fuel processing subsystem

(76) Inventors: Jeroen Valensa, New Berlin, WI (US); Michael J. Reinke, Franklin, WI (US); Robert J. Wilson, Warrington, PA (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/760,563

(22) Filed: Jan. 20, 2004

(51) Int. Cl. G05D 23/00

(52) U.S. Cl. 165/287

(57) ABSTRACT

A reformate cooling system is provided for use in a fuel processing subsystem including a process water flow that supplies water to a fuel flow at various locations in the fuel processing subsystem. The reformate cooling system includes a heat exchanger capable of completely vaporizing a portion of the process water flow while bringing the reformate and the portion of the process water flow to a common exit temperature. The common exit temperature is dynamically controllable to a desired temperature range for optimal removal of carbon monoxide from the reformate flow. The portion of the process water flow is recombined with a remainder of the process water to be utilized as steam and/or water in the fuel processing subsystem.

### FIELD OF THE INVENTION

This invention relates to reformate cooling systems for use in fuel processing subsystems, and in more particular applications, to cooling systems for a reformate flow for fuel cell systems, such as proton exchange membrane (PEM) fuel cell systems.

### BACKGROUND OF THE INVENTION

In many PEM fuel cell systems, a fuel such as methane or a similar hydrocarbon fuel is converted into a hydrogen-rich stream for the anode side of the fuel cell. In many systems, humidified natural gas (methane) and air are chemically converted to a hydrogen-rich stream known as reformate by a fuel processing subsystem of the fuel cell system. This conversion takes place in a reformer where the hydrogen is catalytically released from the hydrocarbon fuel. A common type of reformer is an Auto-thermal Reactor (ATR), which uses air and steam as oxidizing reactants. As the hydrogen is liberated, a substantial amount of carbon monoxide (CO) is created which must be reduced to a low level (typically less than 10 ppm) to prevent poisoning of the PEM membrane.

The catalytic reforming process consists of an oxygenolysis reaction with an associated water-gas shift [CH₄+H₂O [symbol] CO+3 H₂, CO+H₂O [symbol] CO₂+H₂] and/or a partial oxidation reaction [CH₄+½ O₂ [symbol] CO+2 H₂]. While the water-gas shift reaction removes some of the CO from the reformate flow stream, the overall reformate stream will always contain some level of CO, the amount being dependent upon the temperature at which the reforming process occurs. FIG. 1 shows typical equilibrium concentrations of reactant gases in steam reforming as a function of temperature. After the initial reactions, the CO level of the reformate flow is well above the acceptable level for the PEM fuel cell. To reduce the CO concentration to within acceptable levels, several catalytic reactions will generally be used in the fuel processing subsystem to remove CO in the reformate flow. Typical reactions for reduction of CO in the reformate flow include the aforementioned water-gas shift, a preferential oxidation reaction, as well as a selective oxidation reaction over a precious metal catalyst (with a small amount of air added to the reformate stream to provide oxygen). Generally, several stages of CO cleanup are required to obtain a reformate stream with an acceptable CO level. Each of the stages of CO cleanup requires the reformate temperature be reduced to precise temperature ranges so that the desired catalytic reactions will occur and the loading amount of precious metal catalyst can be minimized.

In this regard, liquid-cooled heat exchangers are frequently employed to control the reformate temperature at each stage because of their compact size when compared to gas-cooled heat exchangers. Because liquid water entering the fuel processing subsystem must be heated so that it can be converted to steam for the reforming reactions, it is thermally efficient to use process water as the liquid coolant for the heat exchangers to cool the reformate flow prior to CO removal. However, such an approach can be difficult to implement. Because the water is a process fluid, its flow rate is determined by the amount of water required for the reforming reactions and therefore cannot be adjusted to control the reformate temperature at the outlet of each heat exchanger. Furthermore, while the process water has adequate heat capacity to absorb heat from the reformate flow, it has a low flow rate in comparison to flow rates that would typically be used for a liquid coolant. Because the majority of the heat capacity of water is latent heat capacity, the water will begin to partially vaporize within the heat exchanger as sufficient heat is transferred from the reformate flow. This makes it difficult to precisely control the temperature of the reformate exiting the heat exchanger. To avoid these problems, others have chosen to use a separate coolant loop to absorb the heat from the reformate stream and either reject the heat into the atmosphere or perform another heat exchange process later in the system, thereby foregoing potential increases in overall system efficiency and reduction in system cost.

### SUMMARY OF THE INVENTION

In accordance with one form of the invention, a reformate cooling system is provided for reducing the temperature of a reformate to within a desired temperature range for use in a fuel processing subsystem. The fuel processing subsystem includes a process water flow that supplies water to a fuel flow at various locations in the fuel processing subsystem. The reformate cooling system includes at least one heat exchanger unit to transfer heat from the reformate flow to a portion of the process water flow. The heat exchanger includes a coolant inlet, a coolant outlet, a coolant flow path to direct the portion of the process water flow from the coolant inlet to the coolant outlet, a reformate inlet, a reformate outlet, and a reformate flow path to direct the reformate from the reformate inlet to the reformate outlet with a concurrent flow relationship between the portion of the process water flow in the coolant flow path and the reformate flow in the reformate flow path. The heat exchanger has sufficient effectiveness to fully vaporize the portion of the process water flow and bring the reformate flow and the portion of the process water flow toward a common exit temperature under normal operating conditions for the fuel processing subsystem.

In one preferred form, the fuel processing subsystem is for use in a fuel cell system, and in a more particular embodiment, a proton exchange membrane fuel cell system.

According to one form, the reformate cooling system further includes an active control loop to control the flow rate of the portion of the process water flow through the heat exchanger to maintain the common exit temperature within the desired temperature range.

In one form, the active control loop is a feedback control loop.

According to one form, the active control loop includes a valve to control the flow rate of the portion of the process water flow.

In one form, the active control loop monitors the reformate outlet temperature.

According to one form, the coolant outlet is connected to an auto-thermal reformer.

In accordance with one form, the reformate cooling system further includes a valve connected to the coolant inlet to control the flow rate of the portion of the process water flow to the coolant inlet, a temperature sensor positioned to measure an outlet temperature of the reformate, and a controller connected to the temperature sensor and responsive thereto to selectively control the portion of the process water flow via the valve to regulate the common exit temperature to a desired temperature range.

According to one form, an auto-thermal reformer receives the portion of the process water flow from the coolant outlet and mixes the portion of the process water flow with the fuel flow.

In one form, a method is provided for operating a reformate cooling system for reducing the temperature of a reformate to within a desired temperature range for use in a fuel processing subsystem, the fuel processing subsystem including a process water flow that supplies water to a fuel flow at various locations in the fuel processing subsystem.

In one form, the method includes the steps of:

flowing a reformate through a first flow path;

flowing a portion of the process water through a second flow path with a concurrent relationship to the first flow path;

transferring heat from the reformate to the portion of the process water whereby the portion of the process water is fully vaporized and the reformate and the portion of the process water approach a common exit temperature;

controlling the portion of the process water flow rate to regulate the temperature of the reformate exiting the heat exchanger; and

supplying reformate within a desired temperature range to a selective oxidizer or other hydrogen purification device or subsystem.

In accordance with one form, the method includes the step of adjusting the temperature range of the reformate exiting the heat exchanger in response to changes in the catalytic activity in the selective oxidizer or other hydrogen purification device or subsystem.

According to one form, the method includes the step of recombining the portion of the process water flow with a remainder of the process water flow.

According to one form, the method includes the step of transferring the recombined process water flow to an auto-thermal reformer.

Other objects, advantages, and features will become apparent from a complete review of the entire specification, including the appended claims and drawings.

### BRIEF DESCRIPTION OF THE DRAWINGS

FIG. 1 is a graph showing the composition of a reformate flow exiting an auto-thermal reformer in relation to reaction temperatures;

FIG. 2 is a diagrammatic representation of a fuel processing subsystem including a reformate cooling system and method embodying the present invention;

FIG. 3 is a diagrammatic representation of the reformate cooling system and method of FIG. 2; and

FIG. 4 is a graph depicting temperature profiles for a reformate flow and a portion of a process water flow as they flow through a heat exchanger of the reformate cooling system of FIGS. 2 and 3.

### DETAILED DESCRIPTION OF THE PREFERRED EMBODIMENTS

While the present invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

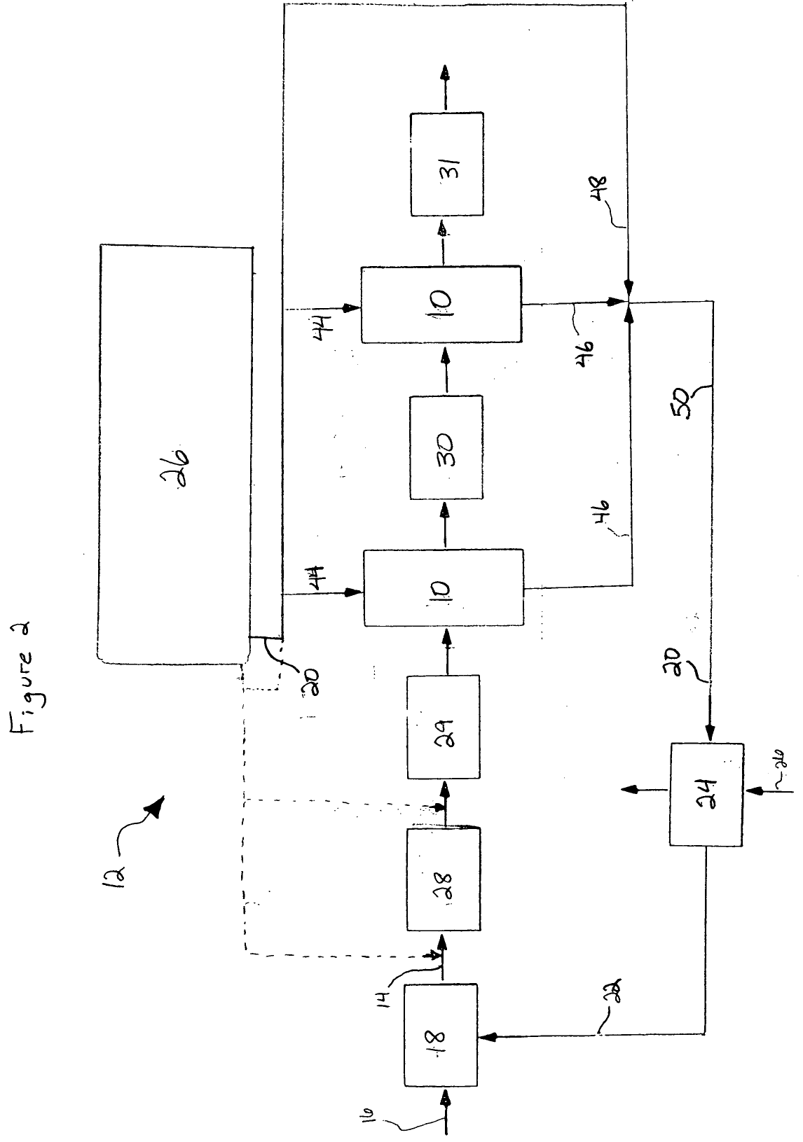

As seen in FIG. 2, a pair of reformate cooling systems 10 embodying the invention are provided for use in a fuel processing subsystem, shown schematically at 12, for producing a reformate flow 14 from a hydrocarbon flow 16 and for reducing a level of carbon monoxide (CO) in the reformate flow 14 for use in a proton exchange membrane fuel cell system (not shown). As used in the specification and claims, the phrase fuel flow is meant to encompass both the hydrocarbon flow 16 and the reformate flow 14 throughout the system and method. While two of the systems 10 are shown, it should be understood that the systems 10 do not depend on each other and can operate independently. Additionally, any number of systems 10 can be utilized as required by the fuel processing subsystem 12. For example, some subsystems 12 may require a single reformate cooling system 10, while others may require three or more of the systems 10. Each of the reformate cooling systems 10 provides an advantageous coolant flow scheme that can allow for simplification and optimization of the varying temperature requirements of fuel processing subsystems.

It should be understood that while the reformate cooling system 10 is described herein in connection with a fuel processing subsystem 12 that it is particularly advantageous for a fuel cell system, and particularly for proton exchange membrane type fuel cell systems, the reformate cooling system may find use in any number of fuel processing subsystems including fuel processing subsystems that are not particularly adapted for use with a fuel cell system or a proton exchange membrane fuel cell system. Accordingly, no limitation to use with fuel cell systems is intended unless specifically recited in the claims.

In the illustrated embodiment, the fuel processing subsystem 12 includes an auto-thermal reformer 18. A commonly used method called steam reforming may be used to produce the reformate flow 14 from the hydrocarbon flow 16 in the auto-thermal reformer 18. The reactions consist of an oxygenolysis reaction, a partial oxidation, and a water-gas shift [CH₄+H₂O [symbol] CO+3 H₂, CH₄+½ O₂ [symbol] CO+2 H₂, CO+H₂O [symbol] CO₂+H₂]. For these catalytic reactions to occur, the reactants must be brought to an elevated temperature typically in excess of 500° C. As shown in the first reaction, a process water flow 20 is used in the form of superheated steam 22 to partially elevate the temperatures of the reactants entering the auto-thermal reformer 18. As in most fuel processing subsystems for fuel cell systems, the necessary heat to create the steam flow 22 must be added to the process water flow 20 from an external source such as a heater or, as shown in FIG. 2, by burning a reformate gas, hydrogen, natural gas, or other hydrocarbon containing combustible mixture 26, such as an anode tail gas stream 26 and transferring heat to the process water flow 20 in a heat exchanger 24 to create the steam flow 22. In the illustrated embodiment, the process water flow 20 is supplied by a suitable pressurized water source 27 such as a single water tank or source, multiple water tanks or sources, a water line with any number of junctions for providing process water to the subsystem, recycled process and/or product water source, or the like.

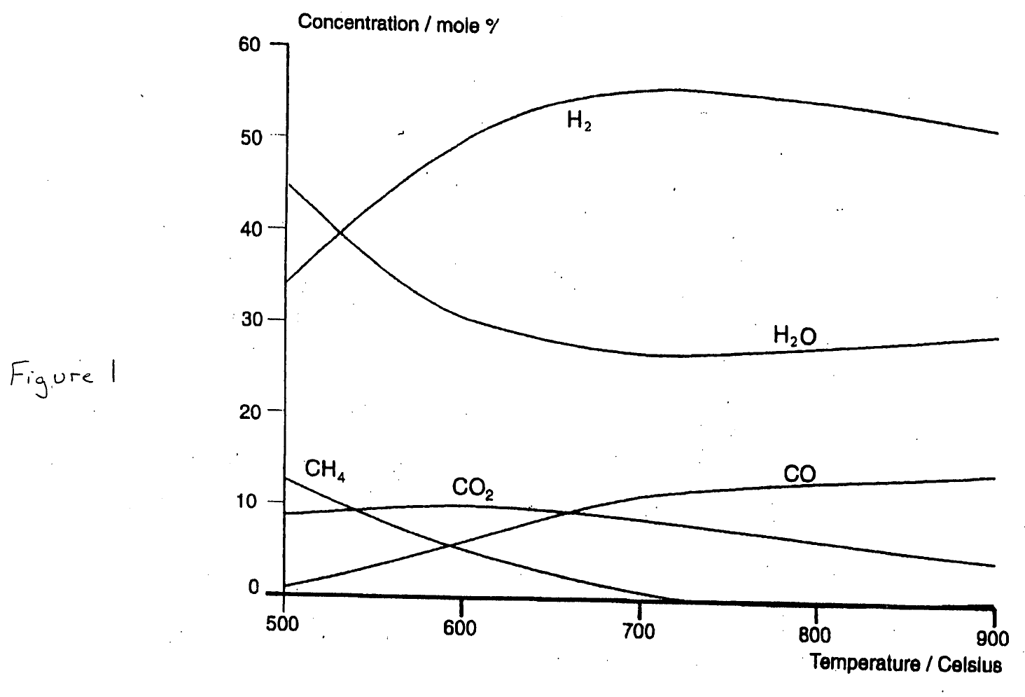

As shown in the above mentioned reactions, CO is created in the reforming process. The CO created must be removed before entering a fuel cell because it is poisonous to the membrane, limiting the fuel cell performance and lifetime. As shown in FIG. 1, the amount of CO created in the reforming reactions is highly dependent upon the reaction temperature. As shown, at higher temperatures, the reactions yield more hydrogen gas useful in the fuel cell, but also yield more poisonous CO. In order to eliminate the poisonous CO from the reformate flow 14, CO elimination stages may be utilized.

In the illustrated embodiment of FIG. 2, after the hydrocarbon flow 16 is used to produce the reformate flow 14 in the auto-thermal reformer 18, the reformate flow 14 is flowed to at least one water-gas shift 28. The water-gas shift 28 is utilized to further remove poisonous CO from the reformate flow 14 and create more hydrogen gas for use in the fuel cell system. The water-gas shift requires water as shown in the water-gas shift reaction [CO+H₂O [symbol] CO₂+H₂]. Optionally, additional water (as indicated by the dotted lines in FIG. 2) may be added at the water-gas shift 28 as required by the fuel processing subsystem 12 to maintain the water-gas shift reaction. The additional water may come from the process water flow 20, water source 26, or any other suitable water source such as a water tank, multiple water tanks, a water line, recycled process water, or the like. Additionally, multiple water-gas shifts 28 and 29 may be utilized to further reduce the amount of poisonous CO in the reformate flow 14.

Even after multiple water-gas shift reactions 28 and 29, the reformate flow 14 still typically contains excessive amounts of poisonous CO in the reformate flow 14. To eliminate more of the poisonous CO, at least one hydrogen purification device or subsystem, such as selective oxidizer 30 may be utilized. Selective oxidation reactions typically require a small amount of air to be added to the reformate flow 14 to provide oxygen as required by the selective oxidation reaction [CO+½ O₂ [symbol] CO₂]. Selective oxidation reactions typically occur over a precious metal catalyst. For the catalytic reaction to occur, the reformate flow 14 must be reduced to a desired temperature range to optimize the efficiency of the precious metal catalyst. Typically, selective oxidation occurs in a temperature range of 130° C. to 180° C. Highly efficient selective oxidation occurs over a much narrower temperature range depending upon the catalyst. To minimize the amount of catalyst required for the selective oxidation reaction, it is preferred that the temperature to which the reformate is cooled by precisely controlled. Additionally, as the catalyst ages, the optimal temperature range may shift, requiring the reformate flow 14 temperature to also shift accordingly. In the embodiment of FIG. 2, multiple selective oxidizers 30 and 31 are utilized and operate at different desired temperature ranges from each other to remove poisonous CO, preferably to a level less than 10 ppm in the reformate flow 14. Each of the reformate cooling systems 10 is used to cool the reformate flow 14 to within the desired temperature range for the respective selective oxidizers 30 and 31.

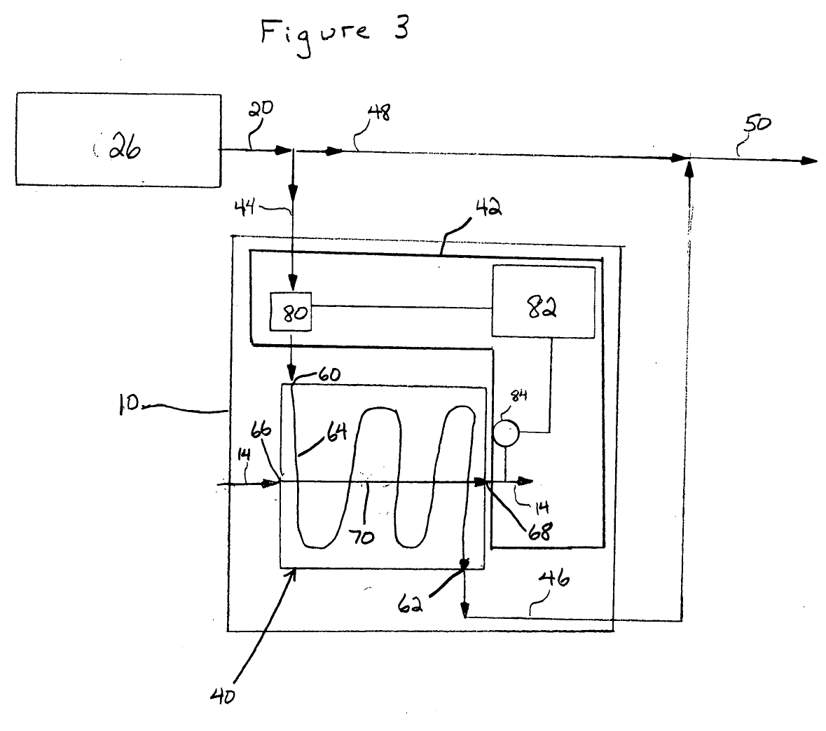

FIG. 3 illustrates a preferred embodiment for each of the reformate cooling systems 10. The system 10 includes a water/reformate heat exchanger 40 and a suitable active control loop 42 to control the flow rate of a portion 44 of the process water flow 20 passing through the heat exchanger 40. The portion 44 of the process water flow 20 is fully vaporized in the heat exchanger 40 and exits the heat exchanger 40 as a steam flow 46. The steam flow 46 is combined with a remainder 48 of the process water flow 20 to create a mixed steam/water flow 50 that may be flowed to the heat exchanger 24 for additional heating as seen in FIG. 2.

It should be understood that the portions 44 of the process water flow 20 may be any amount of the process water flow 20 as required by each of the reformate cooling systems 10. Additional process water flow 20 may be utilized, as previously described, in the water gas shifts 28/29 as required for the water gas shift reactions.

With reference to FIG. 3, the heat exchanger 40 includes a coolant inlet 60, a coolant outlet 62, a coolant flow path 64 to direct the portion 44 of the process water flow 20 from the inlet 60 to the outlet 62, a reformate inlet 66, a reformate outlet 68, and a reformate flow path 70 to direct the reformate flow 14 from the reformate inlet 66 to the reformate outlet 68, with a concurrent flow relationship between the portion 44 of the process water flow 20 in the coolant flow path 64 and the reformate flow 14 in the reformate flow path 70. The heat exchanger 40 has a sufficient effectiveness to fully vaporize the portion 44 of the process water flow 20 and bring the reformate flow 14 and the portion 44 of the process water flow 20 toward or to a common exit temperature under normal operating ranges and conditions for the fuel processing subsystem 12. As seen in FIG. 3, in some highly preferred embodiments, the concurrent flow relationship can also include a cross-flow sub-component if required to achieve full vaporization of the portion 44 of the process water flow 20 and the common exit temperature of the portion 44 and the reformate flow 14.

In the preferred embodiment of FIG. 3, the active control loop 42 is provided in the form of a feedback control loop that includes a valve 80, a controller 82, and a temperature sensor 84. In a preferred embodiment of the system 10, the valve 80 is used to control the flow rate of the portion 44 of the process water flow 20. The valve 80 may be any suitable flow control valve known in the art that is capable of operating at the elevated temperatures and pressures of the fuel processing subsystem 12. The valve 80 may be connected to the controller 82 via a mechanical, electrical, or similar connection means. The controller 82 may be any conventional controller such as a feedback controller, PLC controller, relay, computer, or similar unit capable of controlling the operation of the valve 80 in response to a signal from the temperature sensor 84. The temperature sensor 84 is connected to the reformate flow 14 exiting the heat exchanger 40 to monitor the temperature of the reformate flow 14 exiting the heat exchanger 40 via the outlet 68. Alternatively, the temperature sensor 84 may optionally be connected to the portion 44 of the process water flow 20 exiting the heat exchanger 40 via the outlet 62 to monitor the temperature of the portion 44 of the process water flow 20. This alternative is available because of the common exit temperature produced by the heat exchanger 40. In yet another embodiment, multiple temperature sensors may be located at both the reformate flow 14 exiting the heat exchanger 40 and the portion 44 of the process water flow 20 exiting the heat exchanger 40 to ensure the flows 14 and 44 are exiting the heat exchanger 40 at or near a common exit temperature. The temperature sensor 84 is also connected via any suitable means (mechanical or electrical) to the controller 82 to transmit the temperature of the flow the temperature sensor 84 is monitoring.

As illustrated in FIG. 3, the temperature sensor 84 is monitoring the temperature of the reformate flow 14 exiting the heat exchanger 40. The temperature sensor transmits the temperature to the controller 82 so that the controller may control the valve 80 to maintain the common exit temperature within the desired range for the respective selective oxidizer 30,31. If the temperature of the reformate flow 14 exiting the heat exchanger 40 is higher than the desired temperature range, the controller 82 will control the valve 80 so that the valve 80 increases the flow rate of the portion 44 of the process water flow 20 through the heat exchanger 40, thereby increasing the quantity of heat transferred from the reformate flow 14 and reducing the outlet temperature thereof. If the temperature of the reformate flow 14 exiting the heat exchanger 40 is lower than the desired temperature range, the controller 82 will control the valve 80 so that the valve 80 decreases the flow rate of the portion 44 of the process water flow 20 though the heat exchanger 40, thereby decreasing the quantity of heat transferred from the reformate flow 14 and increasing the exit temperature thereof.

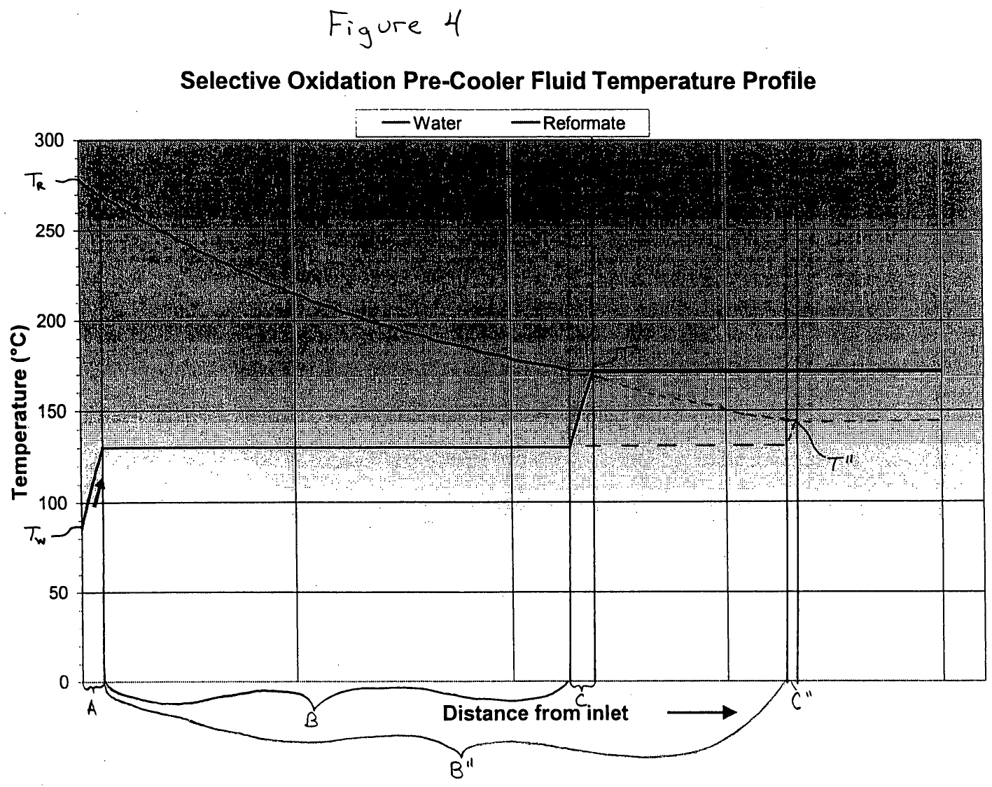

The latent heat of the portion 44 of the process water flow 20 is significantly greater than the heat capacity of the vaporized portion of the steam flow 68. As illustrated in FIG. 4, the temperature (T_{w}) of the portion of the process water 64 rapidly increases over a distance A from the inlet 60 of the heat exchanger 40. The rate of increase of T_{w} is related to the heat capacity of the liquid water in the portion 44 of the process water flow 20. T_{w} rapidly increases until it reaches the boiling point of water at the heat exchanger pressure. The temperature (Tᵣ) of the reformate flow 14 decreases in value as heat is transferred from the reformate flow 14 to the portion 44 of the process water flow 20. Over a distance B, T_{w} does not change as all of the heat transferred from the reformate flow 14 is used as latent heat to vaporize the portion 44 of the process water flow 20. At the distance A+B, the portion 44 of the process water flow 20 has been fully vaporized into steam. Once the portion 44 of the process water flow 20 has been fully vaporized from a liquid to a vapor, the temperature T_{w} rapidly increases over a distance C until it reaches a pinch point or common exit temperature T′. Over the distance C, the temperature gradient between the reformate flow 14 and the portion of the steam flow 68 continually decreases until each flow is at or within a narrow range of the common exit temperature.

As illustrated in FIG. 4, the dashed lines indicate the changes in temperature profiles when the flow rate of the portion 44 of the process water flow 20 is increased. The distance A″ will be approximately the same as the distance A, but would slightly increase (not shown for simplicity), as the heat capacity of liquid water is not significantly influential on the process thermodynamics. The distance B″ does increase significantly as the mass of liquid water in the portion 44 of the process water flow 20 is influential because of the latent heat of liquid water is significantly larger than the heat capacity of liquid water. As more heat is required for vaporizing the portion 44 of the process water flow 20, less heat is available for superheating the portion 44. The resulting common exit temperature T″ is lower than the common exit temperature T′ in the previous example. It should be understood that the values presented in FIG. 4 are a somewhat generic representation of temperature profiles of the portion 44 of the process water flow 20 and the reformate flow 14 and actual values may differ depending on the particular operating parameters of each application.

Precise temperature control is critical for CO removal from the reformate flow 14. Therefore, the reformate cooling system 10 must be capable of precise control of the temperature Tᵣ of the reformate flow as it exits the heat exchanger 40. As illustrated in FIG. 4, because the entire portion 44 of the process water flow 20 is completely vaporized before it exits the heat exchanger 40, the common exit temperature can be precisely controlled as a function of the flow rate of the portion 44 of the process water flow 20. It can be readily seen from FIG. 4 that the majority of heat transferred from the reformate flow 14 is used to vaporize the portion 44 of the process water flow 20, allowing precise temperature control for superheating the steam flow 46 as shown over the distances C and C″.

In the preferred embodiments, it should also be readily apparent that it is desirable for the water to be delivered to the heat exchanger 40 at a pressure which is below the saturation pressure of water at the desired exit temperature. According to one form, this equates to a maximum water pressure of 4.7 bar (absolute) at a desired common exit temperature T′ of 150° C. In one form, the maximum allowable water pressure could be as low as 2.7 bar (absolute) at a desired common exit temperature T′ of 130° C., which corresponds to the low end of the selective oxidation temperature range of many systems. The above illustrated forms are acceptable water pressures for typical “low pressure” fuel processing subsystems, which are generally used in stationary power generation systems which utilize a fuel cell stack operating at or near ambient pressure. Systems where the fuel cell stack operates at elevated pressures above ambient will require a “high pressure” fuel processing subsystem, which will limit the minimum temperature attainable through the present invention. Additionally, by having the desired exit temperature near the water saturation temperature, the portion 44 of the process water flow 20, once fully vaporized, only experiences a small rise in temperature before it reaches the common exit temperature T′. This results in reduced stress in the heat exchanger 40 at the locations where the portion 44 of the process water flow 20 achieves full vaporization. However, it should be understood that fuel processing subsystems can be designed to operate at other temperatures and pressures.

Dynamic temperature control is also critical for CO removal from the reformate flow 14. As the precious metal catalyst used in the selective oxidizers 30,31 ages, the optimal temperature for CO removal also changes. The reformate cooling system 10 is readily capable of handling such dynamic temperature control. Either through an automated sensing system or through manual input, the controller 82 may be manipulated so as to adjust the desired temperature range either up or down as the catalyst requires.

Multiple reformate cooling systems 10 may oftentimes be necessary to remove sufficient CO from the reformate flow 14. As illustrated in FIG. 2, multiple systems 10 and multiple selective oxidizers 30,31 are utilized to remove CO from the reformate flow 14. Typically in this process, the flow rate of the portion 44 of the process water flow 20 is much larger in the upstream (in relation to reformate flow) system 10 than the flow rate of the portion 44 of the process water flow 20 in the downstream system 10 because the temperature of the reformate flow 14 entering the upstream system 10 is much higher than the temperature of the reformate flow 14 entering the downstream system 10. It is irrelevant to the overall system thermal efficiency if more heat is removed at one system 10 than another because all portions 44 of the process water flow 20 are preferably recycled back into the fuel processing subsystem 12 and used as steam in the auto-thermal reformer 18.

While the reformate cooling systems 10 have been described in connection with selective oxidizers 30,31, it should be understood that either or both of the reformate cooling systems 10 can be used with other types of hydrogen purification devices, of which the water-gas shifts 28,29 and the selective oxidizers 30,31 are common examples.

Overall thermal efficiency is improved because of the integration of the present invention. Large quantities of heat are required at the auto-thermal reformer 18 to convert the hydrocarbon flow 16 into the hydrogen rich reformate flow 14. As shown in FIG. 1, the temperature in the auto-thermal reformer 18 must be sufficiently high to produce a high concentration of hydrogen. All of the heat input into the portion(s) 44 of the process water flow 20 would either be wasted or inefficiently transferred if a separate cooling loop were used to cool the reformate flow 14 before each of the selective oxidizers 30,31. By using the portion(s) 44 of the process water flow 20 to directly recover the heat from the reformate flow 14 to recycle back into the auto-thermal reformer 18 or other units in the fuel processing subsystem 12, the number of heat transfer processes can be decreased while the thermal transfer efficiency can be increased.

1. A reformate cooling system for reducing the temperature of a reformate to within a desired temperature range for use in a fuel processing subsystem, the fuel processing subsystem including a process water flow that supplies water to a fuel flow in the fuel processing subsystem; the reformate cooling system comprising:
at least one heat exchanger unit to transfer heat from the reformate flow to a portion of the process water flow, the at least one heat exchanger including a coolant inlet, a coolant outlet, a coolant flow path to direct the portion of the process water flow from the coolant inlet to the coolant outlet, a reformate inlet, a reformate outlet, and a reformate flow path to direct the reformate flow from the reformate inlet to the reformate outlet with a concurrent flow relationship between the portion of the process water flow in the coolant flow path and reformate flow in the reformate flow path, the heat exchanger having a sufficient effectiveness to fully vaporize the portion of the process water flow and bring the reformate flow and the portion of the process water flow toward a common exit temperature under normal operating conditions for the fuel processing subsystem;
a valve connected to the coolant inlet to control the flow rate of said portion of the process water flow to the coolant inlet;
a temperature sensor positioned to measure an outlet temperature of the reformate;
a controller connected to the temperature sensor and responsive thereto to selectively control the portion of the process water flow via the valve to regulate the common exit temperature to a desired temperature range.

2. The reformate cooling system of claim 1 wherein an auto-thermal reformer receives the portion of the process water flow from the coolant outlet and mixes the portion of the process water flow with the fuel flow.

3. The reformate cooling system of claim 1 wherein the temperature sensor is positioned at the reformate outlet.

4. The reformate cooling system of claim 1 wherein the temperature sensor is positioned at the coolant outlet.

5. The reformate cooling system of claim 1 wherein the controller is electronically coupled to the temperature sensor.

6. A method of operating a reformate cooling system for reducing the temperature of a reformate to within a desired temperature range for use in a fuel processing subsystem, the fuel processing subsystem including a process water flow that supplies water to a fuel flow in the fuel processing subsystem, the method comprising the steps of:
flowing a reformate through a first flow path;
flowing a portion of the process water through a second flow path with a concurrent flow relationship to the first flow path;
transferring heat from the reformate to the portion of the process water whereby the portion of the process water is fully vaporized and the reformate and the portion of the process water approach a common exit temperature; and
controlling the portion of the process water flow rate to regulate the temperature of the reformate exiting the first flow path.

7. The method of claim 6 further comprising the step of adjusting the temperature range of the reformate exiting the first flow path in response to changes in catalytic activity in a hydrogen purification device receiving said reformate exiting the first flow path.

8. The method of claim 6 further comprising the step of recombining the portion of the process water flow with a remainder of the process water flow.

9. The method of claim 8 further comprising the step of transferring the recombined process water flow to an auto-thermal reformer.

10. A reformate cooling system for reducing the temperature of a reformate to within a desired temperature range for use in a fuel processing subsystem, the fuel processing subsystem including a process water flow that supplies water to a fuel flow in the fuel processing subsystem; the reformate cooling system comprising:
at least one heat exchanger unit to transfer heat from the reformate flow to a portion of the process water flow, the at least one heat exchanger including a coolant inlet, a coolant outlet, a coolant flow path to direct the portion of the process water flow from the coolant inlet to the coolant outlet, a reformate inlet, a reformate outlet, and a reformate flow path to direct the reformate flow from the reformate inlet to the reformate outlet with a concurrent flow relationship between the portion of the process water flow in the coolant flow path and reformate flow in the reformate flow path, the heat exchanger having a sufficient effectiveness to fully vaporize the portion of the process water flow and bring the reformate flow and the portion of the process water flow toward a common exit temperature under normal operating conditions for the fuel processing subsystem;
an active control loop to control the flow rate of the portion of the process water flow through the heat exchanger to maintain the common exit temperature within the desired temperature range.

11. The reformate cooling system of claim 10 wherein the active control loop is a feedback control loop.

12. The reformate cooling system of claim 11 wherein the active control loop includes a valve to control the flow rate of the portion of the process water flow.

13. The reformate cooling system of claim 12 wherein the active control loop monitors the reformate outlet temperature.

14. The reformate cooling system of claim 10 wherein the coolant outlet is connected to an auto-thermal reformer.
